(19) United States
(12) Patent Application Publication
(10) Pub. No.: US 2025/0386934 A1
(43) Pub. Date: Dec. 25, 2025

(54) Extension guide

(71) Applicant: Samet Kalip Ve Madeni Esya San Ve Tic. A.S., Istanbul (TR)

(72) Inventors: Christian Prentner, Götzis (AT); Nurettin Güzeltepe, Istanbul (TR); Himmet Tanriverdi, Istanbul (TR)

(21) Appl. No.: 19/107,631

(22) PCT Filed: Dec. 2, 2022
(86) PCT No.: PCT/TR2022/051401

§ 371 Date: Feb. 28, 2025

(51) Int. Cl. A47B 88/493; A47B 88/473; A47B 88/497

(52) U.S. Cl. CPC A47B 88/493; A47B 88/473; A47B 88/497; A47B 2210/001; A47B 2210/0018; A47B 2210/0037

(57) ABSTRACT

The invention relates to an extension guide (1) for mounting a movable furniture part linearly movably along an extension direction (2), comprising a carcass rail (10) which can be fixed to a furniture carcass, a drawer rail (50) which can be fixed to the movable furniture part, and a linearly movable center rail (30) arranged between the carcass rail (10) and the drawer rail (50), at least one load-transmitting inner carriage (20) arranged between the carcass rail (10) and the center rail (30) and at least one load-transmitting outer carriage (40) arranged between the center rail (30) and the drawer rail (50). The extension guide 1 can be easily and cost-effectively adapted to different rail lengths in that that the inner carriage (20) and/or the outer carriage 40 is/are formed of a plurality of segments (21, 24, 40.1, 41, 42) which are connected to one another, preferably detachably connected.

The invention relates to an extension guide for mounting a movable furniture part linearly movably along an extension direction, comprising a carcass rail which can be fixed to a furniture carcass, a drawer rail which can be fixed to the movable furniture part, a linearly movable center rail arranged between the carcass rail and the drawer rail, at least one load-transmitting inner carriage arranged between the carcass rail and the center rail and at least one load-transmitting outer carriage arranged between the center rail and the drawer rail.

Extension guides of the type mentioned above may be used for the mounting of a movable furniture part, for example a drawer, to a furniture carcass, for example a cabinet. The drawer may thus be fixed to the drawer rail and the carcass rail may be fixed to the cabinet. To enable opening and closing of the drawer, relative movement between the cabinet and the drawer may be enabled by the extension guide. That is, the drawer may be linearly movable along an extension direction, in order to allow for opening the drawer by extending it and for closing the drawer by retracting it. For this purpose, the drawer rail may be mounted in a linearly movable manner relative to the carcass rail.

To expand the way that the drawer can be pulled out, for example to provide that it can be pulled completely so that the entire interior of the drawer becomes accessible, a linearly movable center rail may be arranged between the carcass rail and the drawer rail.

Relative movement between the drawer rail and the center rail may be facilitated by an outer carriage, that may roll in between the drawer rail and the center rail. The outer carriage may be linearly movable in the extension direction. The outer carriage may thus guide the drawer rail on the center rail and further transmit a load from the drawer, for example a weight of the drawer and/or the contents of the drawer, to the center rail.

The center rail may be movable relative to the carcass rail. To facilitate movement of the center rail relative to the carcass rail, suitable means, for example rollers, may be provided between the center rail and the carcass rail. These means may thus guide the center rail on the carcass rail and further transmit a load from the center rail, for example a load transmitted from the drawer rail to the carcass rail. For this purpose, at least one load-transmitting inner carriage arranged between the carcass rail and the center rail may be provided. The inner carriage may be linearly movable in the extension direction.

To achieve a reproducible, even movement of the rails relative to each other, an extension device according to the invention may comprise a synchronizing device that may enable defining the position and/or speed relations between individual, several or all rails and/or carriages of the extension guide.

Extension guides may be provided on opposing lateral sides of the drawer relative to the extension direction. Extension guides on opposing sides may be designed in a mirror-inverted way to one another.

An extension guide of the type mentioned in the beginning is known from EP 2 538 818 B1. The extension guide comprises a carcass rail, a center rail and first carriage arranged in between. The extension guide further comprises a drawer rail and a second carriage arranged in between the center rail and the drawer rail. Further, a synchronizing device is provided that is effective between the first carriage and the drawer rail. The synchronizing device comprises two pinions that are rotationally fixed to one another and that are rotatably mounted on the center rail. The first pinion meshes with a rack disposed at the first carriage and the second pinion meshes with a rack disposed at the drawer rail. The first carriage further comprises rollers mounted rotatably about a vertical axis for lateral guidance of the center rail on the carcass rail.

Carriages of known extension guides are shaped as integral parts so that for different rail lengths and/or different desired travel lengths of rails and/or carriages different carriages must be used.

Thus, the technical problem to be solved by the invention is to provide an extension guide that can be easily and cost-effectively adapted to different rail lengths.

This problem is solved in that that the inner carriage is formed of a plurality of segments which are connected to one another, preferably detachably connected, and/or that the outer carriage is formed of a plurality of segments which are connected to one another, preferably detachably connected.

Extension guides typically be produced in large numbers, so that it may be especially desirable to reduce production costs of extension guides to a minimum. An effective way of reducing production costs is to design parts so that they can be used in different applications. In the context of extension guides, to account for different lengths of rails of extension guides used for different purposes, for example for larger and smaller drawers, it may thus be desirable to be able to use identically designed segments of carriages. Further, the requirements regarding mechanical robustness may differ between different applications, for example based on the weight of a drawer and/or the weight of the expected contents of a drawer.

According to the invention, it may be possible to choose an appropriate number of segments to fulfil the load-transmitting and guidance requirements for an extension guide. Further, it may be possible to provide for appropriate spacing between segments of a carriage, for example based on the length of the rails of the extension guide and/or the desired travel distance of the carriage on the rail.

If it is provided that the inner carriage has at least two carriage segments which are indirectly or directly connected to one another, the total length of the inner carriage may be selected based on the desired travel and/or length of the rail without the need for a re-design of the carriage segments. For instance, for short rails and/or travel distances, two carriage segments may be connected directly to one another. For longer rails and/or travel distances, two carriage segments may be indirectly connected to one another. For example, a spacer may be provided in between the carriage segments, the carriage segments being connected indirectly to one another by means of the spacer. It is also conceivable that an extension guide is configured to be used with a heavy movable furniture part, so that more than two carriage segments may be connected directly or indirectly to one another to increase load-bearing capacity.

Quick and simple connection of the carriage segments may be achieved if the connection between the carriage segments is established by means of a connecting element and a connecting counter element, the connection preferably enabling positive-locking, friction-locking or friction-locking and positive-locking transmission of force. Preferably, the connection may be established without the use of tools.

In this context, a preferred design of the connection of the carriage segments may be such that the connecting element has a connecting insert, that the connecting counter element has a connecting receptacle designed at least partially corresponding to the connecting insert, and that the connecting insert can be accommodated at least in part in the connecting receptacle. This may in particular provide for a secure between the connecting element and the connecting counter element.

If it is provided that the connecting element has a connecting neck which has a smaller cross-section than the connecting insert, that the connecting counter element has a connecting recess in a wall of the connecting receptacle, the connecting recess being designed to correspond to the connecting neck at least partially, and that the connecting neck can be at least partially received in the connecting recess, a space-saving design may be achieved.

Enhanced reliability of the connection may be achieved if it is provided that the connecting counter element has at least one connecting projection and/or at least one connecting retraction in the region of the connecting receptacle, that the connecting element has at least one connecting retraction at least partially corresponding to a connecting projection of the connecting counter element and/or at least one connecting projection at least partially corresponding to a connecting projection of the connecting counter element, wherein a connecting projection can be at least partially accommodated in a respectively corresponding connecting retraction. In this way, the amount of effort and time necessary to establish the connection may not be increased. In particular, the connection may still be established without the use of tools. Nevertheless, the connecting projection and the connecting retraction may provide additional strength of the connection.

An overall length of the inner carriage, particularly in the extension direction, may be easily adaptable if it is provided that the inner carriage has at least one linking segment by means of which the carriage segments are connected to one another, the carriage segments and the linking segment preferably being arranged in succession in the extension direction. The linking segment may be designed to account for the desired length of the carriage segment. In particular, the linking segment may be of a relatively simple design compared to the carriage segments. It may thus be more cost-effective to provide for different designs and/or sizes of linking segments for different applications (e.g. lengths of rails) than to provide different designs and/or sizes of carriage segments.

Preferably, a first carriage segment may be followed by a linking segment and a linking segment may be followed by a further carriage segment along the extension direction. It is conceivable, however, that carriage segments and linking segments overlap to some extent along the extension direction. In this case, it may be provided that the center (e.g., center of volume, center of area and/or center of mass) of the carriage segments and linking segments may follow one another in the extension direction.

Additionally or alternatively, it may be provided that a linking segment connects more than two carriage segments to one another. In essence, any number, combination and/or arrangement of carriage segments and linking segments may be provided. For example, it is conceivable that more than one linking segment is provided between two or more carriage segments, i.e., two or more carriage segment being connected by more than one linking segment.

A variant of the invention may be characterized in that at least one carriage segment and/or at least one linking segment has a connecting element or a connecting counter element on the leading and/or trailing end viewed with respect to the extension direction. A leading end may face in the extension direction, while a trailing end may face against the extension direction.

According to a preferred variant of the invention it may be provided that at least one carriage segment is provided with at least one second guide means, said second guide means preferably being designed as a roller. By means of the second guide means, guidance of the carriage segment in the direction of the extension direction and support transverse to the extension direction, in particular in the vertical direction, may be achieved. In this context, it may be provided that the second guide means is at least partially in contact with a support surface of the carcass rail. The second guide means may thus transfer a load, for example due to a weight of a drawer and/or its contents to the carcass rail. For example, the inner carriage may transfer the load from the center rail to the carcass rail at least partially by means of the second guide means. If the second guide means is designed as a roller, smooth running of the carriage segment on the carcass rail and/or the center rail may be achieved.

The support surface may be an upper surface of an upper wall of the carcass rail. It is conceivable that second guide means are provided that are at least partially in contact with the support surface and/or that second guide means are provided that are at least partially in contact with a lower surface of the upper wall opposite the support surface. For example, the carriage segment may comprise an upper part and a base part, in between which a rail receptacle may be provided. The upper wall of the carcass rail may be at least partially received in the rail receptacle. In this case, it may be provided that one or both of the base part and the upper part are equipped with second guide means.

Additionally or alternatively, the carriage segment may be provided with at least one first lateral guide means, the first lateral guide means preferably being designed as a roller, that may further preferably be rotatable about a vertical axis. By means of the first lateral guide means, guidance of the carriage segment in the direction of the extension direction and support transversely with respect to the extension direction, in particular in the horizontal direction, may be achieved. The first lateral guide means may at least partially be in contact with a side section of the carcass rail. The first lateral guide means may provide lateral support and smooth running of the center rail on the carcass rail. The first lateral guide means may for this purpose at least partially be in contact with a first side wall of the center rail.

It is conceivable that the first lateral guide means are provided on the base part of the carriage segment.

If it is provided that the outer carriage has at least two running segments which are connected to one another indirectly or directly, the total length of the outer carriage may be selected based on the desired travel and/or length of the rail without the need for a re-design of the carriage segments. For instance, for short rails and/or travel distances, two first running segments may be connected directly to one another. For longer rails and/or travel distances, two running segments may be indirectly connected to one another. For example, a spacer may be provided in between the running segments, the running segments being connected indirectly to one another by means of the spacer. It is also conceivable that an extension guide is configured to be used with a heavy movable furniture part, so that more than two running segments may be connected directly or indirectly to one another to increase load-bearing capacity.

It may further be provided that the connection enables positive-locking, friction-locking, or friction-and positive-locking force transmission. In this way, the running segments may be quickly and easily connected to one another. Preferably, the connection may be established without the use of tools.

In this context, a preferred design of the connection of the running segments may be such that the connection is established by means of at least one latching projection, which is preferably tongue-shaped, and a latching receptacle at least partially corresponding to the latching projection, wherein the latching projection can be at least partially received in the latching receptacle, and wherein at least one of the running segments has at least one latching projection and/or at least one latching receptacle. In this way a secure connection may be achieved.

According to an advantageous variant of the invention, it may be provided that the latching projection has at least one latching element, which is preferably designed as a latching nose, that the latching receptacle has at least one latching stop, and that a latching connection between the latching projection and the latching receptacle is established at least partially by the latching element engaging at least partially behind the latching stop. The latching stop may be designed as an edge, preferably as a straight edge.

Overall length of the outer carriage, particularly in the extension direction, may be easily adaptable if it is provided that the outer carriage has at least one base segment by means of which the running segments are connected to one another, the running segments preferably being disposed in opposite end regions of the base segment with respect to the extension direction.

Additionally or alternatively, it may be provided that a base segment connects more than two running segments to one another. In essence, any number, combination and/or arrangement of running segments and base segments may be provided. For instance, it may also be conceivable that two or more running segments are connected to one by more than one base segment.

A variant of the invention may be characterized in that the base segment has at least one latching projection and/or at least one latching receptacle.

According to a preferred variant of the invention it may be provided that at least one running segment has at least one third guide means, the third guide means preferably being designed as a roller, that may be further preferably rotatable about a horizontal axis. By means of the third guide means guidance of the running segment in the direction of the extension direction and a support transverse to the extension direction, in particular in the vertical direction, may be achieved. In this context, it may be provided that the third guide means is at least partially in contact with a top wall of the center rail. The third guide means may thus transfer a load, for example due to the weight of the drawer and/or its contents to the center rail. For example, the outer carriage may transfer the load from the drawer rail to the center rail at least partially by means of the third guide means. If the third guide means is designed as a roller, smooth running of the running segment on the center rail and/or the drawer rail may be achieved.

Additionally or alternatively, that the running segment may have at least one third lateral guide means, the third lateral guide means preferably being designed as a roller, that further preferably may be rotatable about a vertical axis. By means of the third lateral guide means, improved guidance of the running segment in the direction of the extension direction and a support transversely with respect to the extension direction, in particular in the horizontal direction, may be achieved. The third lateral guide means may be at least partially in contact with a first side wall of the center rail. The third lateral guide means may enhance lateral support and smooth running of the drawer rail on the center rail. The third lateral guide means may for this purpose at least partially be in contact with a side wall of the drawer rail.

It is conceivable that the third lateral guide means is provided on a lateral running segment, that may be angled off from the running segment preferably at a right angle, and that may preferably be integrally formed with the running segment.

According to an advantageous embodiment of the invention, it is proposed that the base segment has at least one fourth lateral guide means, the fourth lateral guide means preferably being designed as a roller, in that by means of the fourth lateral guide means guidance of the base segment in the direction of the extension direction and a support transverse to the extension direction, in particular in the horizontal direction, is achieved, and in that the fourth lateral guide means is at least partially in contact with a second side wall of the center rail. Like the third lateral guide means, the fourth lateral guide means may provide lateral support and smooth running of the drawer rail on the center rail. The fourth lateral guide means may for this purpose at least partially be in contact with a side wall of the drawer rail, that may be opposed to the side wall that the third lateral guide means may be at least partially in contact with.

It is conceivable that the fourth lateral guide means is provided on the base segment. In particular, the base segment may comprise a top part and a side guide, that may be angled off, preferably at a right angle, from the top part. Preferably, the side guide may be manufactured integrally with the base segment. The fourth lateral guide means may be arranged at the side guide.

The invention will be explained in more detail below with reference to an example of an embodiment shown in the figures. The figures show:

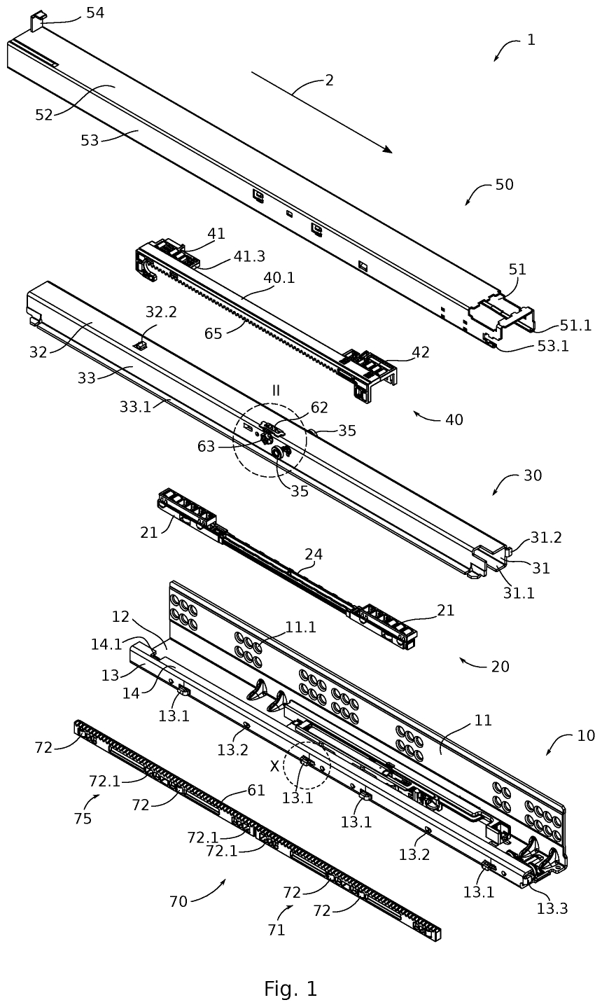

FIG. 1: a schematic exploded view of an extension guide 1,

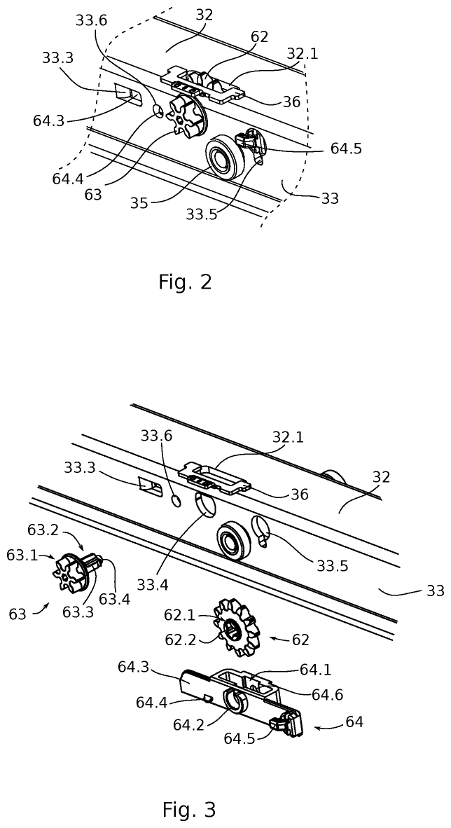

FIG. 2: an enlarged view of detail II according to FIG. 1,

FIG. 3: a schematic exploded view of components shown in FIG. 3,

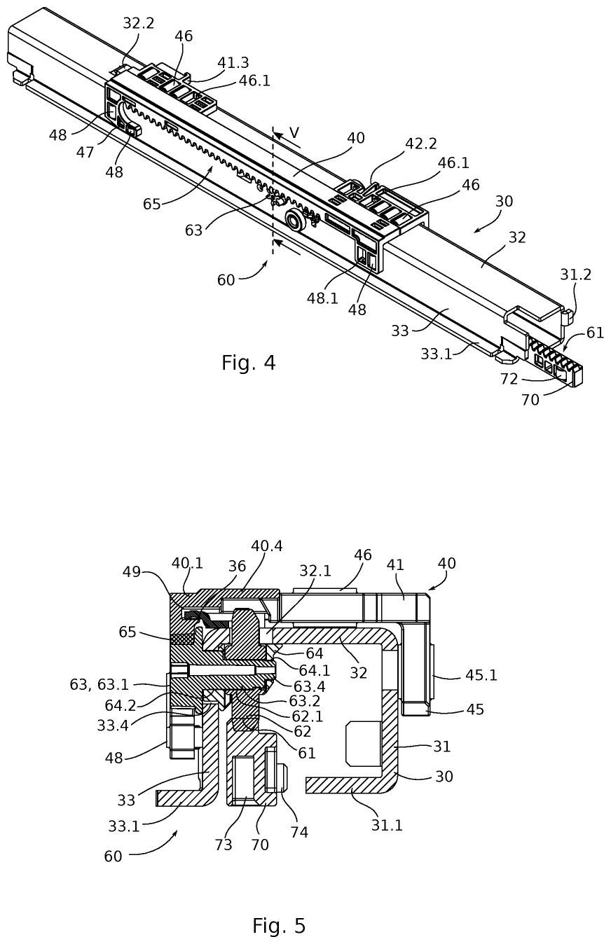

FIG. 4: a schematic view of a center rail 30 combined with a synchronizing device 60,

FIG. 5: a sectional view at location V according to FIG. 4,

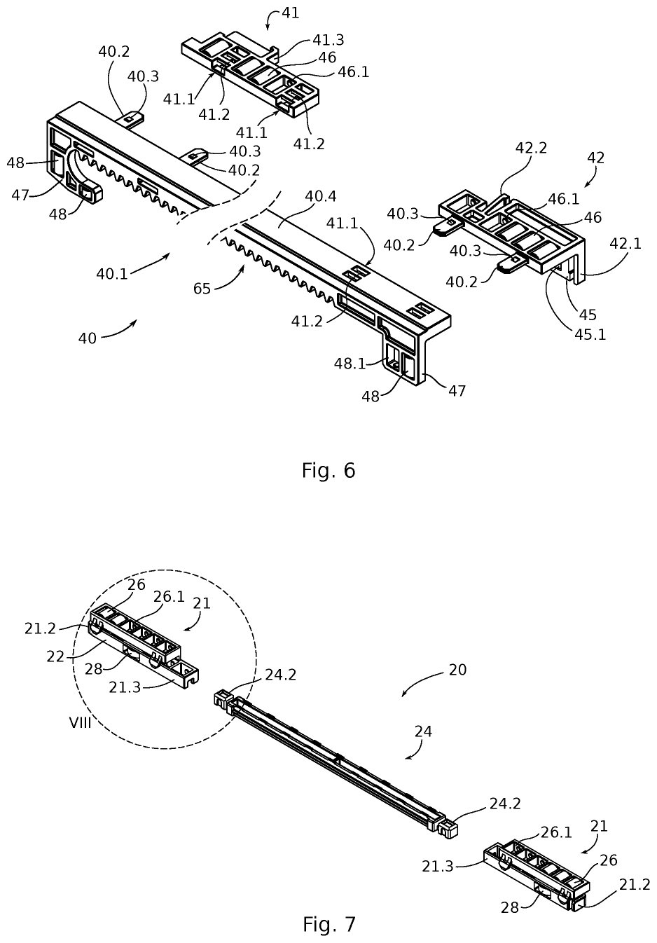

FIG. 6: a schematic exploded view of an outer carriage 40,

FIG. 7: a schematic exploded view of an inner carriage 20,

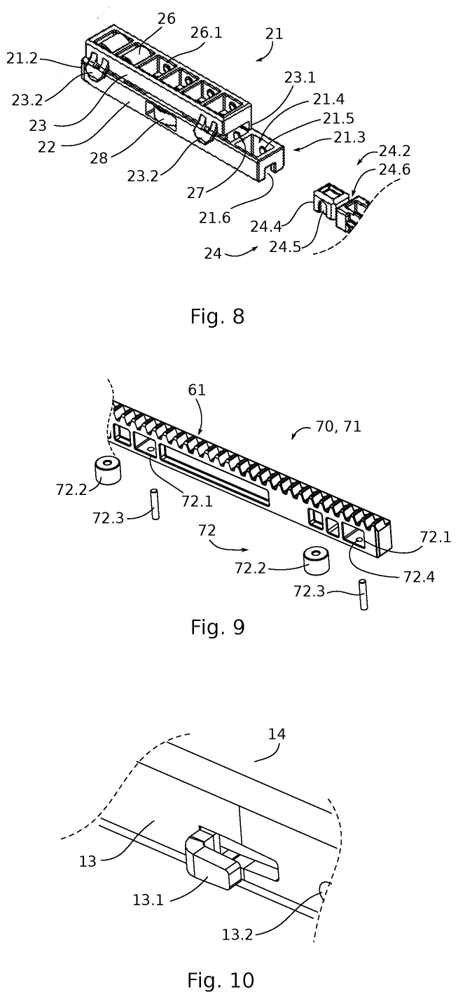

FIG. 8: an enlarged view of detail VIII according to FIG. 7,

FIG. 9: a cropped schematic view of an attaching element 70,

FIG. 10: an enlarged view of detail X according to FIG. 1,

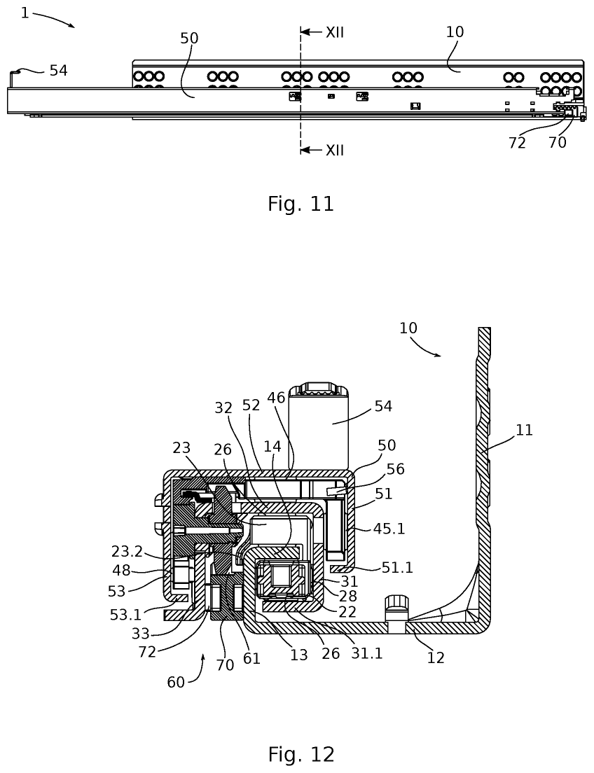

FIG. 11: a schematic side view of an extension guide 1,

FIG. 12: a sectional view at location XII according to FIG. 11.

FIG. 1 shows a schematic exploded view of an extension guide 1. Accordingly, the extension guide 1 may comprise a drawer rail 50 and a carcass rail 10.

The drawer rail 50 may be fixed to a movable furniture part, in particular to a drawer. As shown in FIG. 1, a drawer stop 54 may be provided on the drawer rail 50 for this purpose. Further coupling points or fastening structures for a direct or indirect coupling to the movable furniture part may be provided.

The carcass rail 10 may be fixed to a furniture carcass, for example to a cabinet. As shown in FIG. 1, the carcass rail 10 may comprise a fastening section 11 provided with mounting bores 11.1. In this case, the carcass rail 10 may be fixed to the furniture carcass with suitable fixing means, for example with screws passing through the mounting bores 11.1 and engaging with the furniture carcass.

The carcass rail may further comprise a bottom 12 that may adjoin the fastening section 11 at a right angle. The side section 13 may adjoin the bottom 12 at a right angle at an opposite side thereof. Adjoining the side section 13 at a right angle, an upper section of the carcass rail 10 may be provided which may on its upper side provide a support surface 14.

As can be further seen in FIG. 1, the extension guide 1 may additionally comprise a center rail 30 arranged between the carcass rail 10 and the drawer rail 50.

To allow a linear movement of the movable furniture part in an extension direction 2, for instance to allow opening and closing of a drawer, the drawer rail 50 may be linearly movable relative to the carcass rail 10 along the extension direction 2. The center rail 30 may also be linearly movable relative to the carcass rail 10 along the extension direction 2. Further, the center rail 30 and the drawer rail 50 may be linearly movable relative to one another in the extension direction 2.

Preferably and according to the embodiment shown, linear movement of the center rail 30 relative to the carcass rail 10 may be enabled and/or facilitated by an inner carriage 20 arranged in between the center rail 30 and the carcass rail 10. The inner carriage 20 may transmit a load, for example a load due to the weight of the drawer, between the center rail 30 and the carcass rail 10. The inner carriage 20 may be linearly movable along the extension direction 2, and may be movable relative to the carcass rail 10 and/or the center rail 30.

Similarly, linear movement of the drawer rail 50 relative to the center rail 30 may be enabled and/or facilitated by an outer carriage 40 arranged in between the center rail 30 and the drawer rail 50. The outer carriage 40 may transmit a load, for example a load due to the weight of the drawer, between the drawer rail 50 and the center rail 30. The outer carriage 40 may be linearly movable along the extension direction 2, and may be movable relative to the center rail 30 and/or the drawer rail 50.

FIG. 1 further shows that the extension guide 1 may comprise a first running surface 61 and a second running surface 65 as well as a first synchronizing wheel 62 and a second synchronizing wheel 63, which may be understood to be parts of a synchronizing device 60 (cf. FIGS. 4 and 5). The synchronizing device 60 may be provided for setting position and/or speed relations between two or more of the carcass rail 10, the inner carriage 20, the center rail 30, the outer carriage 40 and/or the drawer rail 50. Preferably, and as shown in the embodiment according to the figures, the synchronizing device 60 enables a defined speed and position relationship between the carcass rail 10, the center rail 30 and the outer carriage 40. In other words, the synchronizing device 60 may be effective between the carcass rail 10 and the outer carriage 40. The synchronizing device 60 will be discussed in more detail further below.

As shown in FIG. 1, the first running surface 61 may be provided on an attaching element 70 that may be detachably connected to the carcass rail 10. In other words, the first running surface 61 of the embodiment shown in the figures is connected indirectly to the carcass rail 10. It is conceivable, however, to provide a first running surface 61 that is connected directly to the carcass rail 10, for example is provided integrally with the carcass rail 10. In any case, it is preferable that the first running surface 61 is connected to the carcass rail 10 in a stationary manner. That is, preferably the first running surface 61 does not move relative to the carcass rail 10 during a movement of the movable furniture part, the center rail 30, the inner carriage 20, the outer carriage 40 and/or the drawer rail 50.

Further, FIG. 1 shows that the second running surface 65 may be directly connected to the outer carriage 40. As in the embodiment shown, preferably the second running surface 65 is designed integrally with the outer carriage 40. However, it is conceivable that the second running surface 65 is connected indirectly to the outer carriage 40, for example provided separate from and connected to the outer carriage 40, in particular similar to the first running surface 61 preferably being indirectly connected to the carcass rail 10.

The first running surface 61 and the second running surface 65 may preferably both be designed as toothed racks. However, it is also conceivable that the running surfaces 61, 65 are designed another way, for example designed with a smooth surface. Furthermore, the running surfaces 61, 65 need not both be designed in the same manner. For instance, only one of the running surfaces 61, 65 may be designed as a toothed rack.

As stated above, the synchronizing device 60 may further comprise a first synchronizing wheel 62 and a second synchronizing wheel 63. As can be seen in FIG. 1, the first synchronizing wheel 62 and the second synchronizing wheel 63 may be rotatably mounted on the center rail 30.

Preferably the second synchronizing wheel 63 and the first synchronizing wheel 62 are arranged on opposite sides of a wall of the center rail 30. In the embodiment shown, the synchronizing wheels 62, 63 are arranged on opposite sides of a second side wall 33 of the center rail 30, the second synchronizing wheel 63 being on the outer side and the first synchronizing wheel 62 being on the inside. As illustrated in FIG. 2, the first synchronizing wheel 62 may partially reach through a synchronizing wheel breakthrough 32.1 provided in the top wall 32 of the center rail 30.

In vicinity to the synchronizing wheel breakthrough 32.1 a support plate 36 may further be provided on the center rail 30. As shown in the figures, the support plate 36 may be essentially shaped as a platelet. The support plate 36 may be fixed to the top wall 32 in any suitable manner and may partially protrude over the edge formed between the top wall 32 and the second side wall 33. Accordingly, as shown in FIG. 2, the support plate 36 may be located partially above the second synchronizing wheel 63.

A preferred way of mounting the synchronizing wheels 62, 63 to the center rail 30 can perhaps best be explained with reference to FIG. 3, which shows a schematic exploded view of components shown in FIG. 2.

Accordingly, the second synchronizing wheel 63 may comprise a head portion 63.1 adjoining a shaft portion 63.2. The head portion 63.1 may be configured to interact with the second running surface 65, preferably to roll on the second running surface 65. In this context, the second synchronizing wheel 63 may preferably be designed as a pinion that is configured to mesh with the second running surface 65, the second running surface 65 preferably being designed as a toothed rack as described above.

Similarly, the first synchronizing wheel 62 may be configured to interact with the first running surface 61, preferably to roll on the first running surface 61. In this context, the first synchronizing wheel 62 may preferably be designed as a pinion that is configured to mesh with the first running surface 61, the first running surface 61 preferably being designed as a toothed rack as described above.

However, if the first running surface 61 and/or the second running surface 65 are designed in a different way, for instance with a smooth surface, the first synchronizing wheel 62 and/or the second synchronizing wheel 63 may be configured accordingly, respectively.

The first synchronizing wheel 62 may preferably, as in the shown embodiment, have a diameter about twice a diameter of the second synchronizing wheel 63. Diameters of the synchronizing wheels 62, 63 may be diameters measured in regions of the synchronizing wheels 62, 63 configured to interact with the respective running surface 61, 65. For example, a diameter of the second synchronizing wheel 63 may be measured at the head portion 63.1. A diameter of a synchronizing wheel 62, 63 may be an outer diameter. When a synchronizing wheel 62, 63 is designed as a pinion, a diameter may be an inside diameter, an outside diameter or a pitch diameter of the pinion.

Returning to the second synchronizing wheel 63, the shaft portion 63.2 may preferably be configured to be at least partially accommodated in a hub 62.1 of the first synchronizing wheel 62. In other words, by an at least partial accommodation of the shaft portion 63.2 of the second synchronizing wheel 63 in the hub 62.1 of the first synchronizing wheel 62, the synchronizing wheels 62, 63 may be attached to one another.

It is further preferable that both the shaft portion 63.2 and the hub 62.1 are provided with at least partially matching profiles to enable a torque to be transmitted between the two at least partially in a positive-locking manner. For this purpose, as shown in the figures, preferably a spline 63.3 may be provided at the shaft portion 63.2 that is configured to engage with an at least partially corresponding mating spline 62.2 provided at the hub 62.1. The spline 63.3 and the mating spline 62.2 may be of any suitable type.

Further, the center rail 30 may comprise a shaft opening 33.4 through which the shaft portion 63.2 can be guided. The shaft opening 33.4 may be designed as a bore in a wall of the center rail 30, preferably as shown as a bore in the second side wall 33.

As can be further gathered from FIG. 3, a synchronizing wheel holder 64 may be provided to mount the first and second synchronizing wheels 62, 63 to the center rail 30. The synchronizing wheel holder 64 may comprise a holding projection 64.3 that may, as depicted, be designed as a tongue. The holding projection 64.3 may be held at a retaining means 33.3 provided at the second side wall 33 of the center rail 30. When the holding projection 64.3 is designed as a tongue, the retaining means 33.3 may be appropriately shaped as a hook in order to hold the holding projection 64.3 to the second side wall 33.

The synchronizing wheel holder 64 may further comprise a holding lug 64.5 that may be received in a latching aperture 33.5 of the center rail 30. As can be seen in FIG. 3, the holding lug 64.5 may preferably be designed as a hook that engages through the latching aperture 33.5. To further secure the position of the synchronizing wheel holder 64 against the center rail 30, additionally or alternatively, a latching projection 64.4 may be provided on the synchronizing wheel holder 64 that is configured to be received in a latching receptacle 33.6 of the center rail 30. Preferably, the latching receptacle 33.6 is provided on the second side wall 33 of the center rail 30.

The synchronizing wheel holder 64 may comprise a receiving space 64.1 in which the first synchronizing wheel 62 can be received partially. Within the receiving space 64.1, a bearing receptacle 64.6 may be provided, in which a bearing projection 63.4 projecting from the shaft portion 63.2 of the second synchronizing wheel 63 can be received and rotatably supported. Further, the synchronizing wheel holder 64 may comprise a bearing portion 64.2 that may be configured to support a region of the shaft portion 63.2 that is not inserted into the hub 62.1. As shown in the presented embodiment, the bearing portion 64.2 may preferably be designed as a bore and may further preferably be located opposite to the bearing receptacle 64.6.

In this way, the synchronizing wheel holder 64 may first be secured to the center rail 30 by engaging the holding projection 64.3 with the retaining means 33.3 and/or by engaging the holding lug 64.5 with the latching aperture 33.5 and/or by engaging the latching projection 64.4 with the latching receptacle 33.6. It should be noted that the bearing portion 64.2 of the synchronizing wheel holder 64 may at least partially project into the shaft opening 33.4 as can be best seen in FIG. 5. This may provide additional support of the synchronizing wheel holder 64 on the center rail 30.

Once the synchronizing wheel holder 64 is secured to the center rail 30, the first synchronizing wheel 62 may be partially inserted into the receiving space 64.1. Afterwards the second synchronizing wheel 63 may be guided with its shaft portion 63.2 through the shaft opening 33.4, the bearing portion 64.2 and the hub 62.1 toward the bearing receptacle 64.6, where it may be received with its bearing projection 63.4. The synchronizing wheels 62, 63 may in this state be rotatably mounted on the center rail 30.

FIG. 4 shows a schematic perspective view of the center rail 30 in combination with the synchronizing device 60 and FIG. 5 shows a sectional view at location V according to FIG. 4.

From the sectional view of FIG. 4 it is apparent that the second synchronizing wheel 63 may mesh with the second running surface 65 provided on the outer carriage 40, and that the first synchronizing wheel 62 may mesh with the first running surface 61 provided on the attaching element 70. Note that FIGS. 4 and 5 do not show the carcass rail 10 to which the attaching element 70 may be attached. As stated above, it is conceivable in the alternative, that the first running surface 61 may also be directly provided on the carcass rail 10.

As can be seen in FIG. 5, the outer carriage 40 may be provided with a slot 49 that may be arranged along the extension direction 2. The slot 49 may partially accommodate the support plate 36. This may ensure that the outer carriage 40 does not lift off the center rail 30. As the second running surface 65 is connected to the outer carriage 40 and the second synchronizing wheel 63 is connected to the center rail 30, the interaction of the support plate 36 and the slot 49 may ensure proper rolling of the second synchronizing wheel 63 on the second running surface 65, in particular proper meshing of the synchronizing wheel 63 with the second running surface 65.

FIG. 6 shows a schematic exploded view of the outer carriage 40. As shown in FIG. 6, the outer carriage 40 may be formed of a plurality of segments 40.1, 41, 42 which may be detachably connected to one another. Preferably, the outer carriage 40 may comprise a first running segment 41, a second running segment 42 and a base segment 40.1.

The running segments 41, 42 may be provided with third guide means 46. The third guide means 46 may preferably be designed as rollers, as in the shown embodiment. The third guide means 46 may be held within third guide means receptacles 46.1 that may be designed as openings within the running segments 41, 42. The third guide means 46 may be rotatable about an axis that is perpendicular to the extension direction 2, preferably an axis that is horizontal. In this way, the running segments 41, 42 may be guided in the extension direction 2 and supported in a transverse direction, preferably in the vertical direction. In other words, the running segments 41, 42 may be supported by the third guide means 46 against the top wall 32 of the center rail 30 (cf. FIG. 5).

As shown in FIG. 6, the running segments 41, 42 may each comprise more than one third guide means receptacle 46.1. However, not all third guide means receptacles 46.1 need necessarily be equipped with a third guide means 46. Rather, the number of third guide means 46 to be disposed within third guide means receptacles 46.1 may be chosen based on the expected load to be transmitted by the running segments 41, 42. In this way, the same design of running segments 41, 42 may be usable with different extension guides 1 which may face different load requirements.

As can further be gathered from FIG. 6, the second running segment 42 may comprise third lateral guide means 45.1. The third lateral guide means 45.1 may be provided on a lateral running segment 45 of the second running segment 42. Preferably, the third lateral guide means 45.1 are designed as rollers. The third lateral guide means 45.1 may essentially be held at the second running segment 42 in the same way as the third guide means 46. However, the third lateral guide means 45.1 may guide the second running segment 42 in the extension direction 2 provide support in a transverse direction, preferably in the horizontal direction. In other words, the second running segment 42 may be supported by the third lateral guide means 45.1 against the first side wall 31 of the center rail 30 (cf. FIG. 5). Hence, the third lateral guide means 45.1 may be rotatable about a vertical axis.

While not visible in the figures, it is preferable that also the first running segment 41 is provided with third lateral guide means 45.1.

The running segments 41, 42 may be detachably connected to the base segment 40.1 and thereby may be detachably connected to one another via the base segment 40.1. As shown in FIG. 6, the connection may be established by latching projections 40.2 protruding from a body of a running segment 41, 42 and/or the base segment 40.1 and correspondingly designed latching receptacles 41.1 provided on the respective other segment 41, 42, 40.1 to be connected. The latching projections 40.2 may be receivable in the latching receptacles 41.1.

Preferably, the latching projections 40.2 further comprise a latching element 40.3 that may be, as shown in FIG. 6, designed as a latching nose. The latching element 40.3 may engage or snap in at least partially behind a corresponding latching stop 41.2 provided at the latching receptacle 41.1.

In the shown embodiment, the first running segment 41 is equipped with two latching receptacles 41.1 and the base segment 40.1 is equipped with two matching latching projections 40.2. Further, the second running segment 42 is equipped with two latching projections 40.2 and the base segment 40.1 is equipped with two matching latching receptacles 41.1. However, different combinations are conceivable.

The outer carriage 40 may be composed such that the running segments 41, 42 are located at opposing end regions of the base segment 40.1 in the extension direction 2. Preferably, the first running segment 41 may be connected to the base segment 40.1 in a first end region and the second running segment 42 may be connected to the base segment 40.1 in a second end region viewed in the extension direction 2.

The base segment 40.1 may comprise a top part 40.4 that may be configured to be arranged at least partially above the top wall 32 of the center rail 30 (cf. FIG. 5). As discussed before, the second running surface 65 may be connected directly or indirectly to the outer carriage 40. In the embodiment shown, the second running surface 65 is integrally formed with the base segment 40.1 of the outer carriage 40, angled off from the top part 40.4 so that it faces the second synchronizing wheel 63, as can be best seen in FIGS. 4 and 5.

Further, the outer carriage 40 may be equipped with fourth lateral guide means 48. As in the presented embodiment, the fourth lateral guide means 48 may be held on side guides 47 that are angled off from the top part 40.4. Similar to the third lateral guide means 45.1 of the second running segment 42, the fourth lateral guide means 48 may preferably be designed as rollers rotatable about a vertical axis. The fourth lateral guide means 48 may be partially received in fourth lateral guide means receptacles 48.1. The fourth lateral guide means receptacle 48.1 may be arranged at the side guides 47 of the base segment 40.1.

By the fourth lateral guide means 48, guidance of the base segment 40.1 in the extension direction 2 as well as support in horizontal direction transverse to the extension direction 2 may be achieved. For example, as in the presented embodiment, the fourth lateral guide means 48 may roll on an outer side of the second side wall 33 (cf. FIG. 5). In other words, the fourth lateral guide means 48 and the third lateral guide means 45.1 may be arranged on opposite sides of the center rail 30.

Preferably the outer carriage 40 may be composed such that the side guides 47 are located at opposing end regions of the base segment 40.1 in the extension direction 2. In this way, the side guides 47 may not interfere with the engagement of the second synchronizing wheel 63 and the second running surface 65.

As can be further seen in FIG. 6, the second running segment 42 may further be equipped with elastically deformable spring attachments 42.1, 42.2. One spring attachment 42.1 may be connected to the lateral running segment 45 of the second running segment 42. This spring attachment 42.1 may serve the purpose of softening an impact of the second running segment 42 with a stop 31.2 located on the first side wall 31 of the center rail 30 (cf. FIGS. 1 and 4). Additionally, one spring attachment 42.2 may be arranged such that it is located above the top wall 32 of the center rail 30. This spring attachment 42.2 may serve the purpose of softening an impact of the second running segment 42 with a stop 56 located on a side wall 51 of the drawer rail 50 (cf. FIG. 12).

FIG. 7 shows a schematic exploded view of the inner carriage 20 and FIG. 8 provides an enlarged view of detail VIII according to FIG. 7. As depicted, the inner carriage 20 may be formed of a plurality of segments 21, 24 which may be detachably connected to one another. Preferably, the inner carriage 20 may comprise two carriage segments 21 and a linking segment 24.

The carriage segments 21 may be provided with second guide means 26. The second guide means 26 may preferably be designed as rollers, as in the shown embodiment. The second guide means 26 may be held within roller receptacles 26.1 that may be designed as openings within upper parts 23 and base parts 22 of the carriage segments 21. The second guide means 26 may be rotatable about an axis that is perpendicular to the extension direction 2, preferably an axis that is horizontal. In this way, the carriage segments 21 may be guided in the extension direction 2 and supported in a transverse direction, preferably in the vertical direction. In other words, the carriage segments 21 may be supported by the second guide means 26 against the support surface 14 of the carcass rail 10 (cf. FIG. 12).

As shown in FIG. 7, the carriage segment 21 may each comprise more than one roller receptacle 26.1. However, not all roller receptacle 26.1 need necessarily be equipped with a second guide means 26. Rather, the number of second guide means 26 to be disposed within the roller receptacle 26.1 may be chosen based on the expected load to be transmitted by the carriage segments 21. In this way, the same design of carriage segments 21 may be usable with different extension guides 1 which may face different load requirements.

As can further be gathered from FIGS. 7 and 8, the carriage segments 21 may comprise first lateral guide means 28. The first lateral guide means 28 may be provided on the base parts 22 of the carriage segments 21. Preferably, the first lateral guide means 28 are designed as rollers rotatable about a vertical axis. The first lateral guide means 28 may guide the carriage segments 21 in the extension direction 2 and provide support in a transverse direction, preferably in the horizontal direction. In other words, the carriage segments 21 may be supported by the first lateral guide means 28 against a side section 13 of the center rail 30 (cf. FIG. 12).

As seen in FIG. 8, the base part 22 and the upper part 23 of the carriage segment 21 may be connected by a wall section 23.1 on one lateral side of the carriage segment 21. In this way, a rail receptacle 27 may be formed between the base part 22 and the upper part 23. The rail receptacle 27 may serve to receive a part of the upper wall of the carcass rail 10 (cf. FIG. 12). The upper wall may comprise the support surface 14 on its upper side.

Further, the carriage segment 21 may be equipped with guide projections 23.2 projecting from the upper part 23 in a lateral direction and downwards toward the base part 22. The guide projections 23.2 may be configured to engage at least partially and/or temporally with the side section 13 of the carcass rail 10 to improve lateral guidance of the carriage segments 21, as can be seen in FIG. 12.

The carriage segments 21 may be detachably connected to the linking segment 24 and thereby may be detachably connected to one another via the linking segment 24. As shown in FIGS. 7 and 8, the connection may be established by means of a connecting element 24.2 and a connecting counter element 21.3. In the embodiment according to the figures, the connecting counter elements 21.3 are arranged at the carriage segments 21 and the connecting elements 24.2 are arranged at the linking segment 24. However, different arrangements are conceivable.

As best visible in FIG. 8, the connecting counter element 21.3 may be provided at the base part 22 of the carriage segment 21.

The connecting counter element 21.3 may comprise a connecting receptacle 21.4 in which a connecting insert 24.4 of the connecting element 24.2 may be received. Accordingly, the connecting receptacle 21.4 may be designed at least partially corresponding to the connecting insert 24.4.

As can be further seen in FIG. 8, adjacent to the connecting insert 24.4, the connecting element 24.2 may comprise a connecting neck 24.6. The connecting neck 24.6 may have a smaller cross section than the connecting element 24.2. In this way, the connecting neck 24.6 may be received in a connecting recess 21.6 that may be formed in a wall of the connecting receptacle 21.4.

Further, within the connecting receptacle 21.4 there may be one or more connecting projections 21.5. The connecting projection 21.5 may protrude from a wall of the connecting receptacle 21.4 toward the inside thereof. Consequently, the connecting insert 24.4 may comprise one or more connecting retractions 24.5 that may be partially correspondingly shaped to the connecting projection 21.5. The connecting projection 21.5 may snap into the connecting retraction 24.5 during insertion of the connecting insert 24.4 into the connecting receptacle 21.4.

In the way described above, force transmission between the connecting element 24.2 and the connecting counter element 21.3 may be achieved essentially in a positive-locking manner. However, it is conceivable that at least partially, force transmission may be achieved in a friction-locking manner. In particular, an interference fit may at least to some degree be provided between the connecting element 24.2 and the connecting counter element 21.3. This may be in addition to the components of the connecting element 24.2 and the connecting counter element 21.3 described above, that may provide largely a positive-locking force transmission.

In the embodiment shown, the carriage segments 21 and the linking segment 24 are arranged in succession to one another in the extension direction 2. As can be seen in the figures, a first carriage segment 21 is followed by the linking segment 24 which is in turn followed by a second carriage segment 21. In this way, the same type of carriage segments 21 may be used for different lengths of rails of the extension guide 1. In order to adapt the inner carriage 20 for longer or shorter rails, only the length of the linking segment 24 may need to be adjusted.

As can be further seen in FIG. 7, the carriage segments 21 may further be equipped with elastically deformable spring attachments 21.2. The spring attachments 21.2 may be connected to the base parts 22 of the carriage segments 21. The spring attachment 21.2 of the carriage segment 21 that is shown in the left of FIG. 7 may serve the purpose of softening an impact of the carriage segment 21 with a first stop 14.1 located below the support surface 14 of the carcass rail 10 (cf. FIG. 1). The spring attachment 21.2 of the carriage segment 21 that is shown in the right of FIG. 7 may serve the purpose of softening an impact of the carriage segment 21 with a second stop 13.3 provided at the side section 13 of the carcass rail 10 (cf. FIG. 1).

As discussed above, the first running surface 61 may be provided on an attaching element 70 that may be detachably connected to the carcass rail 10. The attaching element 70 may be one part. However, preferably and as per the embodiment shown in the figures, the attaching element 70 may be designed in multiple parts. For example, as shown in FIG. 1, the attaching element 70 may comprise a first attaching segment 71 and a second attaching segment 75 which may follow one another in the extension direction 2. The first running surface 61 may thus be arranged on both attaching segments 71, 75.

A preferred way of detachably connecting the attaching element 70 to the carcass rail 10 may be as follows: As shown in FIG. 1, receiving elements 13.1 may be provided on the side section 13 of the carcass rail 10. The receiving elements 13.1 may be hook shaped. Corresponding to the receiving elements 13.1, the attaching element 70 may comprise receptacles 73 (cf. FIG. 5) that may receive the receiving elements 13.1. The receptacles 73 may be accessible from below, so that the attaching element 70 may be connected to the carcass rail 10 by placing the receptacles 73 above the receiving elements 13.1 and subsequently lowering the attaching element 70. Owing to the hook shaped design of the receiving element 13.1 and the corresponding design of the receptacles 73, the attaching element 70 may be supported against the carcass rail 10 at least both in the extension direction 2 and in the lateral horizontal direction perpendicular to the extension direction 2.

Further, the attaching element 70 may comprise latching projections 74 projecting toward the side section 13 of the carcass rail 10 (cf. FIG. 5). The latching projections 74 may be received in correspondingly designed positioning receptacles 13.2 provided on the side section 13. The latching projections 74 may snap into the positioning receptacles 13.2 during lowering of the attaching element 70, i.e., while inserting the receiving elements 13.1 into the receptacles 73.

As can be seen in FIG. 1, the extension guide 1 may comprise first guide means 72 for guiding the center rail 30 and for supporting the center rail 30 in the horizontal direction. The first guide means 72 may be designed as first guide rollers 72.2 rotatable about a vertical axis. The first guide means 72 may be connected to the carcass rail 10. Preferably, and as shown in the figures, the first guide means 72 are provided on the attaching element 70.

For this purpose, the attaching element 70 may comprise first guide means receptacles 72.1. The first guide means receptacle 72.1 may partially accommodate the first guide rollers 72.2. Preferably the first guide rollers 72.2 are rotatably mounted by means of roller pins 72.3 that may be rotatably received in pin receptacles 72.4 that may be provided within the first guide means receptacles 72.1.

As shown in FIG. 1, the attaching element 70 may comprise more than one first guide means receptacle 72.1. Further, each of the attaching segments 71, 75 may comprise more than one first guide means receptacle 72.1. However, not all first guide means receptacles 72.1 need necessarily be equipped with a first guide means 72. Rather, the number first guide means 72 to be disposed within first guide means receptacles 72.1 may be chosen based on the expected load to be transmitted between the carcass rail 10 and the center rail 30. In this way, the same design of attaching elements 70 and/or attaching segments 71, 75 may be usable with different extension guides 1 which may face different load requirements.

As best seen in FIG. 12, at least part of the first guide means 72 may be in contact with an inner side of the second side wall 33 of the center rail 30. In particular, they may roll on the inner side of the second side wall 33 during linear movement of the movable furniture part.

Returning to FIG. 1, it is apparent that first guide means 72 may be provided essentially over the whole length of the carcass rail 10. In this way, improved lateral guidance of the center rail 30 on the carcass rail 10 is achieved. However, it is also conceivable that only at least two thirds or at least three quarters of the length of the carcass rail 10 are equipped with first guide means 72, for example being designed taking into account the requirements for guiding the center rail 30.

FIG. 11 shows a schematic side view of an extension guide 1 and FIG. 12 shows a sectional view at location XII according to FIG. 11. The way a load, for example a load due to a weight of a drawer, is transmitted to the furniture carcass is perhaps best explained based on FIG. 12.

As stated above, the drawer rail 50 may be attached to the movable furniture part. A vertical load may be transmitted between the top wall 52 of the drawer rail 50 and the top wall 32 of the center rail 30 through the third guide means 46 of the outer carriage 40. A horizontal load may be transmitted between one side wall 51 of the drawer rail 50 and the first side wall 31 of the center rail 30 through the third lateral guide means 45.1 of the outer carriage 40. Further, a horizontal load may be transmitted between another side wall 51 of the drawer rail 50 and the second side wall 33 of the center rail 30 through the fourth lateral guide means 48 of the outer carriage 40. Additionally, vertical loads that may lead to a lifting-off of the drawer rail 50 from the center rail 30 may be compensated by lifting rollers 35 provided on side walls 31, 33 of the center rail 30 that may engage with bent off portions 51.1, 53.1 adjoining the side walls 53 of the drawer rail 50 (cf. FIG. 1).

Between the top wall 32 of the center rail 30 and the support surface 14 of the carcass rail 10, a vertical load may be transmitted through the second guide means 26 of the inner carriage 20. Further, vertical loads may be transmitted between a first bend 31.1 angled off of the first side wall 31 of the center rail 30 on its bottom side and the upper segment of the carcass rail 10 through the second guide means 26 provided on the base part 22 of the inner carriage 20. Horizontal loads may be transmitted between the first side wall 31 of the center rail 30 and the side section 13 of the carcass rail 10 through the first lateral guide means 28 of the inner carriage 20. Further, horizontal loads may be transmitted between the second side wall 33 of the center rail 30 and the side section 13 of the carcass rail 10 through the first guide means 72 that may be provided on the attaching element 70.

In the following, the function of the presented embodiment of an extension guide 1 according to the invention is explained based on an extension (opening) and a retraction (closing) operation of the movable furniture part.

When the movable furniture part is in a closed state, the extension guide 1 may be in a retracted state. The retracted state may correspond to the state shown in FIG. 11.

In the retracted state, a movement of the inner carriage 20 against the extension direction 2 may be prohibited by the spring attachment 21.2 facing against the extension direction 2 resting on the first stop 14.1 of the carcass rail 10.

Movement of the center rail 30 against the extension direction 2 may be prohibited by the outer carriage 40 resting against a stop 32.2 provided on the center rail 30 (cf. FIG. 4). This may inhibit movement of the outer carriage 40 against the extension direction 2. Thus, rotation of the second synchronizing wheel 63 in a counterclockwise direction as seen in FIG. 1 may be inhibited. Consequently, because the first synchronizing wheels 62, 63 may be connected in a rotationally fixed manner, rotation of the first synchronizing wheel 62 in the counterclockwise direction may be inhibited. Based on this, relative movement between the first synchronizing wheel 62 and the first running surface 61 may be inhibited, thus inhibiting relative movement between the center rail 30 and the carcass rail 10.

Movement of the drawer rail 50 against the extension direction 2 may be prohibited by the stop 56 of the drawer rail 50 resting against a counter stop 41.3 located at the first running segment 41 (cf. FIGS. 1, 4 and 6).

During an opening movement of the drawer, the drawer rail 50 may be moved in the extension direction 2 relative to center rail 30. The outer carriage 40 may be moved relative to the center rail 30 by means of the third guide means 46, the fourth lateral guide means 48 and the third lateral guide means 45.1 rolling in between respective walls of the outer carriage 40 and the center rail 30. The outer carriage 40 may move relative to the center rail 30 at half the speed of the relative movement between the drawer rail 50 and the center rail 30.

The relative movement of the outer carriage 40 and the center rail 30 may cause rolling of the second synchronizing wheel 63 on the second running surface 65. In this way, the second synchronizing wheel 63 may be rotated by the relative movement between the outer carriage 40 and the center rail 30.

The rotation of the second synchronizing wheel 63 may be transmitted to the first synchronizing wheel 62, that may be connected to the first synchronizing wheel 62 in a rotationally fixed manner. A thus-induced rotation of the first synchronizing wheel 62 may cause the first synchronizing wheel 62 to roll on the first running surface 61. That is, rotation of the first synchronizing wheel 62 may cause relative motion between the center rail 30 and the first running surface 61, and thus may cause relative motion between the center rail 30 and the carcass rail 10.

The inner carriage 20 may be moved relative to the carcass rail 10 by means of the second guide means 26 and first lateral guide means 28 rolling in between respective walls of the center rail 30 and the carcass rail 10. The inner carriage 20 may move relative to the carcass rail 10 at half the speed of the relative movement between the center rail 30 and the carcass rail 10.

The speed relations between moving rails and/or carriages may depend on the ratio of the diameter of the first synchronizing wheel 62 to the second synchronizing wheel 63.

In the shown embodiment, the synchronizing wheels 62, 63 are mounted on the center rail 30, the second running surface 65 is connected to the outer carriage 40 and the inner carriage 20 is provided between carcass rail 10 and center rail 30. If the above-mentioned ratio of diameters is chosen to be 2, the speed relation between carcass rail 10, inner carriage 20, center rail 30, outer carriage 40 and drawer rail 50 may be 0:1/6:1/3:2/3:1 (speed of drawer rail 50 assumed to be 1). If the ratio is chosen to be 2.0, as preferred and as in accordance with the embodiment shown in the figures, the relation may be 0:1/4:1/2:3/4:1. This may be a preferred relation because it provides an even distribution of speeds and travel length of the rails and carriages of the extension guide 1 during extension and retraction.

When the movable furniture part is in a fully open state, the extension guide 1 may be in a fully extended state.

In the extended state, a further movement of the inner carriage 20 in the extension direction 2 may be prohibited by the spring attachment 21.2 facing in the extension direction 2 resting on the second stop 13.3 of the carcass rail 10.

Further movement of the center rail 30 in the extension direction 2 may be prohibited by the outer carriage 40 resting against a stop 31.2 provided on the center rail 30 (cf. FIG. 4) with its spring attachment 42.1. This may inhibit further movement of the outer carriage 40 in the extension direction 2. Thus, rotation of the second synchronizing wheel 63 in a clockwise direction as seen in FIG. 1 may be inhibited. Consequently, because the first synchronizing wheels 62, 63 may be connected in a rotationally fixed manner, rotation of the first synchronizing wheel 62 in the clockwise direction may be inhibited. Hence, relative movement between the first synchronizing wheel 62 and the first running surface 61 may be inhibited, thus inhibiting further relative movement between the center rail 30 and the carcass rail 10 in the extension direction 2.

Further movement of the drawer rail 50 in the extension direction 2 may be prohibited by a stop of the drawer rail 50 located at the inside of the side wall 51 (not shown in the figures) resting on a spring attachment 42.2 located at the second running segment 42 (cf. FIGS. 1, 4 and 6).

From the open state, closing of the movable furniture part may lead the extension guide 1 back to the retracted state described above. For the closing process, the same explanations are analogously valid that were made above for the opening process.

1-16 (canceled)

17. An extension guide for mounting a movable furniture part linearly movably along an extension direction, the extension guide comprising:
a carcass rail configured to be attached to a furniture carcass;
a drawer rail configured to be attached to the movable furniture part;
a linearly movable center rail arranged between the carcass rail and the drawer rail;
at least one load-transmitting inner carriage arranged between the carcass rail and the center rail; and
at least one load-transmitting outer carriage arranged between the center rail and the drawer rail;
wherein at least one of the inner carriage or the outer carriage is formed of a plurality of segments connected to one another.

18. The extension guide of claim 17, wherein:
the segments are detachably connected to one another.

19. The extension guide of claim 17, wherein:
the plurality of segments of the inner carriage includes at least two carriage segments which are directly or indirectly connected to one another.

20. The extension guide of claim 19, wherein:
the carriage segments are connected by a connection between a connecting element and a connecting counter element.

21. The extension guide of claim 20, wherein:
the connection between the connecting element and the connecting counter element enables a positive-locking, friction-locking or positive locking and friction-locking transmission of force.

22. The extension guide of claim 20, wherein:
the connecting element includes a connecting insert; and
the connecting counter element includes a connecting receptacle configured such that the connecting insert can be received at least in part in the connecting receptacle.

23. The extension guide of claim 22, wherein:
the connecting element includes a connecting neck having a smaller cross-section than the connecting insert; and
the connecting counter element has a connecting recess in a wall of the connecting receptacle, the connecting recess being configured such that the connecting neck can be received at least in part in the connecting recess.

24. The extension guide of claim 22, wherein:
at least one of the connecting element or the connecting counter element includes at least one connecting projection; and
the other of the connecting element or the connecting counter element includes at least one connecting retraction;
wherein the connecting retraction is configured such that the connecting projection can be received at least in part in the connecting retraction.

25. The extension guide of claim 17, wherein:
the plurality of segments of the inner carriage includes at least two carriage segments and at least one linking segment connecting the two carriage segments to one another.

26. The extension guide of claim 25, wherein:
the two carriage segments and the linking segment are arranged in succession in the extension direction such that a first one of the carriage segments is followed by the at least one linking segment which is followed by a second one of the carriage segments.

27. The extension guide of claim 25, wherein:
at least one of the carriage segments or the at least one linking segment includes a connecting element or a connecting counter element on a leading or trailing end of the segment viewed with respect to the extension direction.

28. The extension guide of claim 17, wherein:
the plurality of segments of the inner carriage includes at least one carriage segment provided with at least one guide configured to guide the carriage segment in the extension direction and to support the carriage segment in a direction transverse to the extension direction.

29. The extension guide of claim 28, wherein:
the at least one guide includes a first guide and a second guide, the first guide being configured as a first roller in contact with a side section of the carcass rail and arranged to support the carriage segment in a horizontal direction, and the second guide being configured as a second roller in contact with the carcass rail and arranged to support the carriage segment in a vertical direction.

30. The extension guide of claim 17, wherein:
the plurality of segments of the outer carriage includes at least two running segments which are directly or indirectly connected to one another.

31. The extension guide of claim 30, wherein:
the at least two running segments are directly or indirectly connected to one another by a connection including at least one latching projection on one of the running segments and a latching receptacle on another of the running segments, the latching receptacle being configured such that the latching projection can be received at least in part in the latching receptacle.

32. The extension guide of claim 31, wherein:
the latching projection includes at least one latching element, the latching receptacle includes at least one latching stop, and a latching connection between the latching projection and the latching receptacle is established at least in part by the latching element engaging behind the latching stop.

33. The extension guide of claim 30, wherein:
the plurality of segments of the outer carriage further includes at least one base segment connecting the running segments to one another, the running segments being disposed on opposite ends of the base segment with respect to the extension direction.

34. The extension guide of claim 33, wherein:
the base segment includes at least one latching projection or at least one latching receptacle.

35. The extension guide of claim 30, wherein:
at least one of the running segments includes a roller guide in contact with a top wall of the center rail and guiding the running segment in the extension direction and supporting the running segment in a vertical direction, and another roller guide in contact with a side wall of the center rail and guiding the running segment in the extension direction and supporting the running segment in a horizontal direction.

36. The extension guide of claim 30, wherein:
the plurality of segments of the outer carriage further includes at least one base segment connecting the running segments to one another, the base segment including a roller guide in contact with a side wall of the center rail and configured to guide the base segment in the extension direction and to support the base segment in a horizontal direction.
